(19) United States
(12) Patent Application Publication
(10) Pub. No.: US 2012/0143497 A1
(43) Pub. Date: Jun. 7, 2012

(54) Method of creating customized exercise routes for a user

(76) Inventor: Iwan Van Hende, Tao-Yuan Hsien (TW)

(21) Appl. No.: 12/960,536

(22) Filed: Dec. 5, 2010

(51) Int. Cl. G01C 21/36

(52) U.S. Cl. 701/432; 701/439

(57) ABSTRACT

A method of creating an exercise route for a user is disclosed. The method includes providing a database having geographic data, and receiving a plurality of input route parameters from the user, the input route parameters including a type of exercise to be performed on the exercise route. The method further includes processing the geographic data from the database and the plurality of input route parameters to define the exercise route from a starting point to an ending point, and presenting the exercise route to the user.

### BACKGROUND OF THE INVENTION

1. Field of the Invention

The invention relates to a personal navigation device, and more particularly, to a personal navigation device that allows a user to input selected route parameters for creating a customized exercise route for the user.

2. Description of the Prior Art

Global Positioning System (GPS) based navigation devices are well known and are widely employed as in-car navigation devices. Common functions of a navigation device include providing a map database for generating navigation instructions that are then shown on a display of the navigation device. These navigation devices are often mounted on or in the dashboard of a vehicle using a suction mount or other mounting means.

The term “navigation device” refers to a device that enables a user to navigate to a pre-defined destination. The device may have an internal system for receiving location data, such as a GPS receiver, or may merely be connectable to a receiver that can receive location data. The device may compute a route itself, or communicate with a remote server that computes the route and provides navigation information to the device, or a hybrid device in which the device itself and a remote server both play a role in the route computation process. Portable GPS navigation devices are not permanently integrated into a vehicle but instead are devices that can readily be mounted in or otherwise used inside a vehicle. Generally (but not necessarily), they are fully self-contained—i.e. include an internal GPS antenna, navigation software and maps and can hence plot and display a route to be taken.

Currently, personal navigation devices used for outdoor activities such as hiking are limited in their options presented to users. Route planning with conventional personal navigation devices is performed by the user entering a starting point and an ending point, with the personal navigation devices creating a planned route for the user based on these criteria. However, there are very few options available to the user for creating varied exercise routes that satisfy additional user requirements. When a user wants to drive from point A to point B as quickly as possible, the personal navigation device has fewer user requirements to satisfy, and usually aims to provide the user with the fastest route possible. However, when it comes to leisure activities or exercise routes where creating the fastest route is not necessarily the most important factor, users demand the ability to create more flexible and diverse routes.

Unfortunately, when creating a route between point A and point B, conventional personal navigation devices always provide the same route and do not offer any alternatives. Sports-based personal navigation devices also do not always provide any personalized routes based on specific user requirements or existing training programs followed by the user.

### SUMMARY OF THE INVENTION

It is therefore one of the primary objectives of the claimed invention to provide a method of creating customized exercise routes for a user in order to satisfy user requirements and provide a more enjoyable and varied exercise experience.

According to an exemplary embodiment of the claimed invention, a method of creating an exercise route for a user is disclosed. The method includes providing a database having geographic data, and receiving a plurality of input route parameters from the user, the input route parameters including a type of exercise to be performed on the exercise route. The method further includes processing the geographic data from the database and the plurality of input route parameters to define the exercise route from a starting point to an ending point, and presenting the exercise route to the user.

It is an advantage that the present invention method provides a large assortment of options to be chosen by the user in order to create a customized exercise route. In this way, the user has considerably more control over what type of route will be selected while still retaining the convenience of the personal navigation device helping plan the route, the user can exercise on a greater variety of routes, and the user can continue training on level-appropriate exercise routes. Moreover, having a greater variety of training options makes it more likely that the user will find and continue with a training program that is enjoyable and challenging to the user.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a block diagram of a personal navigation device according to the present invention.

FIG. 2 is a screen showing input route parameter preferences selectable by the user.

FIGS. 3-5 are block diagrams of personal navigation devices according to other embodiments of the present invention.

### DETAILED DESCRIPTION

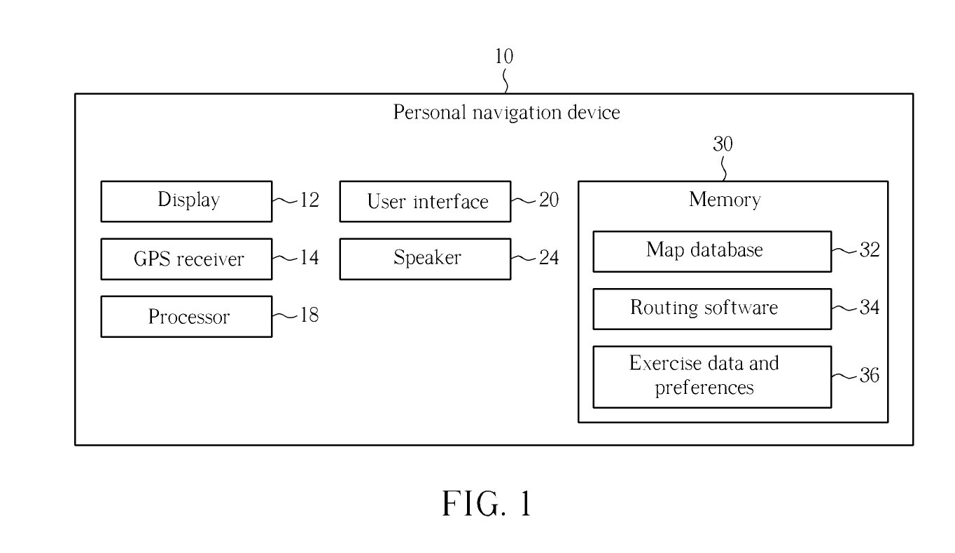

Please refer to FIG. 1. FIG. 1 is a block diagram of a personal navigation device 10 according to the present invention. The personal navigation device 10 contains a display 12 which can be a touch sensitive display, a GPS receiver 14 for receiving the current coordinates of the personal navigation device 10, a processor 18 for controlling operation of the personal navigation device 10, a user interface 20, a speaker 24 for outputting audio instructions to the user, and a memory 30. The memory 30 is used to store a map database 32 containing map data and points of interest. The memory 30 also stores routing software 34 used to create routes for the user to follow. User data such as exercise data and preferences 36 is also stored in the memory 30 in order to have a record of what training level the user is at and what exercise routes the user prefers.

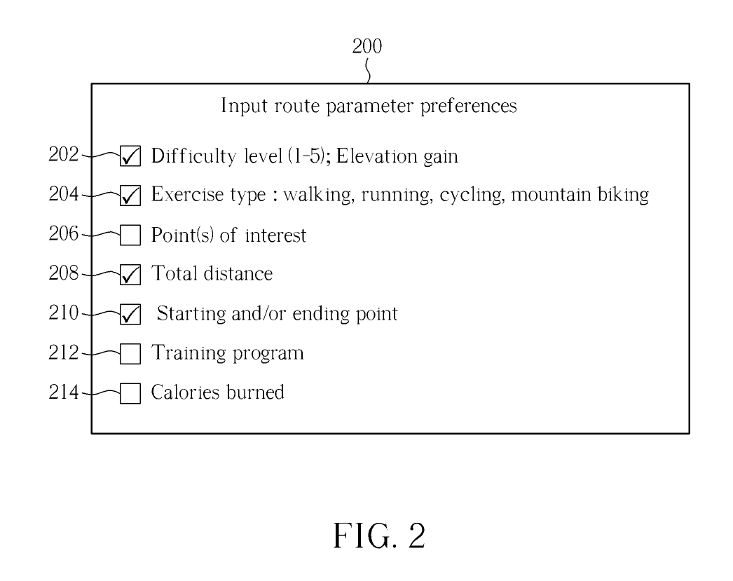

The user can select a variety of input route parameters, each of which is further customizable. Please refer to FIG. 2. FIG. 2 is a screen 200 showing input route parameter preferences selectable by the user. When creating an exercise route, the user may select one or more input route parameter preferences for customizing the type of route the user prefers. In screen 70, seven different checkboxes 202, 204, 206, 208, 210, 212, 214 are shown by way of example. Four of the checkboxes 202, 204, 208, 210 have been selected for illustrating which input route parameter preferences are selected by the user when creating a new exercise route. In each case, when one of the input route parameter preferences is selected by the user, the user can be presented with an additional screen corresponding to each individual input route parameter preferences for specifying more detail about the user's input route parameter preferences. A description of each of the seven input route parameter preferences will be given below.

The difficulty level 202 option can be given a numerical value, such as on a scale of 1 to 5, with 1 being the easiest and 5 being the most difficult. In an embodiment, the difficulty level 202 can be measured by the elevation gain of the exercise route, which can be a net elevation gain (elevation gain minus elevation loss) or can be a gross elevation gain (adding all elevation gains while ignoring elevation loss). In general, the steeper and the more climbing done on an exercise route, the more difficult the exercise route is as compared to flat exercise routes. It will be appreciated that other factors besides elevation gain, such as terrain, can also be used for determining the difficulty level 202.

The exercise type 204 option presents the user with the chance to select one of several different types of exercise. Different exercise types such as walking, running, cycling, and mountain biking can potentially all be done one different types of terrain. By specifying the exercise type 204, the personal navigation device 10 can limit the search for a suitable exercise route to only those that are appropriate for the chosen exercise type 204.

The point of interest 206 option lets the user request that the created exercise route include one or more points of interest selected by the user. If a large number of points of interest are selected or if a whole category of point of interest in a region are selected, then the created exercise route can try to include as many of the points of interest as possible while at the same time satisfying all of the other input route parameter preferences indicated by the user.

If the user has selected other input route parameters such as distance or starting or ending point, these other selected input route parameters may preclude the routing software 34 from including all points of interest chosen by the user. In this situation, a maximum number of points of interest pertaining to the user's selection will be included. For example, if a user has specified that an exercise route has parameter preferences of a distance of 10 kilometers, a designated starting and ending point, and another parameter preference of seeing as many points of interest within a “Scenic Points” category as possible, the routing software 34 will attempt to fit in as many of the points of interest as possible. If the “Scenic Points” category contains five points of interest in that area, but only three of them can be included in a 10-kilometer route due to the distance constraint, then the routing software 34 will only include those three points of interest in the generated exercise route. On the other hand, when creating an exercise route with no other limiting constraints on the exercise route besides the selected points of interest, then all selected points of interest can be included on the created exercise route.

The total distance 208 option allows the user to limit the created exercise route to one that is approximately a specified distance. The user can also specify any other limitations on the distance, such as less than but not greater than the specified distance, or the distance of the exercise route being within 20% of the specified distance.

The starting and ending point 210 option allows the user to specify one or both of the starting point and the ending point of the exercise route. The starting point can be the same as the ending point of the route or they can be different points. In addition, for instances where the starting point and the ending point are either the same or close to one another, the user can also specify whether there should be any overlap of the departure route and the return route of the exercise route. In other words, the user can specify if any of the route be repeated, or if the departure route and the return route should be different from one another. By choosing a different return route than a departure route, the user can select a complete exercise route having more variety of scenery than if the return route was identical to the departure route. One of the main goals of the present invention is to provide the user with many different options for searching for and creating a customized exercise route so that the exercise route can feel fresh and new to the user, thereby making it more likely that the user will enjoy exercising and continue to use the personal navigation device 10 for creating future exercise routes.

The training program 212 option allows the user to create exercise routes that are consistent with an existing training program that the user is already following and has been entered into the exercise data and preferences 36 portion of memory 30. Based on the results of previous exercise routes that the user has completed, the training program 212 can create an appropriate exercise route for the user on a given day.

The calories burned 214 option can be used to select an exercise route of an appropriate distance and terrain according to a selected exercise type to ensure that the number of calories that a user burns while exercising on the created exercise route is approximately equal to a specified number. In order to more accurately calculate this value, the user will first have to input various body parameters into the personal navigation device 10 such as the user's height and weight. An exercise route can then be created which aims to enable the user to burn the specified number of calories while exercising.

The input route parameter preferences shown on the screen 200 in FIG. 2 allow the user to filter down search results when the personal navigation device 10 searches for and creates exercise routes. With every exercise route calculation, alternative routes will be created whenever possible. In this way, the user will be able to select a fresh and appealing exercise route while at the same time selecting an exercise route that conforms to the selected input route parameter preferences.

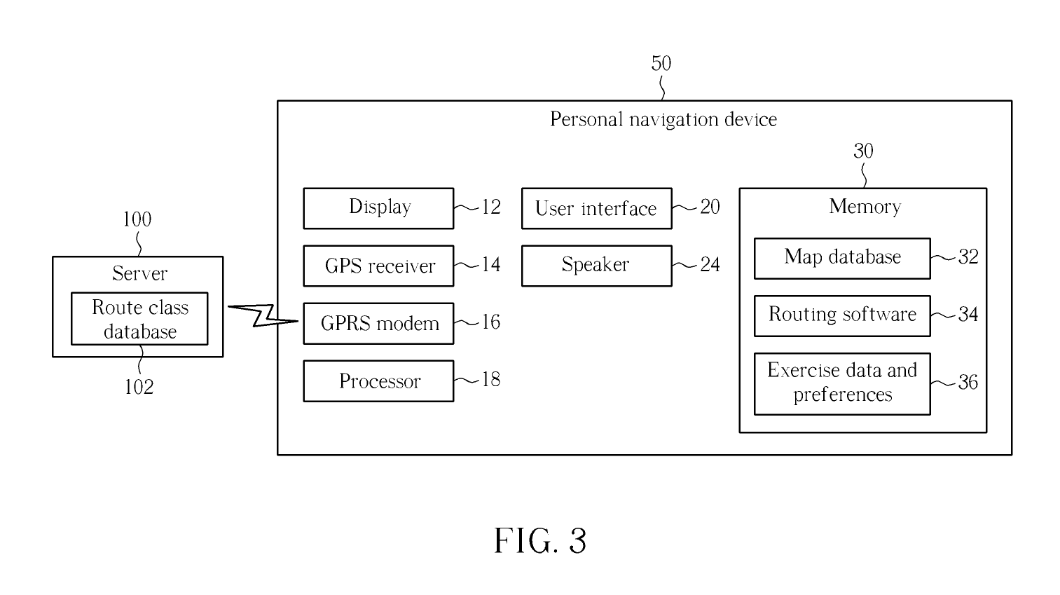

Please refer to FIG. 3. FIG. 3 is a block diagram of a personal navigation device 50 according to another embodiment of the present invention. Differing from the personal navigation device 10 shown in FIG. 1, the personal navigation device 50 contains a General Packet Radio Service (GPRS) modem 16 for providing internet access. Description of the GPRS modem 16 is not intended to limit the scope of the present invention, and any wireless modem that can connect to the Internet can be used instead of the GPRS modem 16.

The GPRS modem 16 allows the personal navigation device 50 to communicate wirelessly with a server 100 via the Internet for accessing a route class database 102 stored in the server 100. Thus, in this embodiment, the map database 32 is stored in the memory 30 of the personal navigation device 50, whereas the route class database 102 is stored remotely in the server 100. The map database 32 provides information such as street map data, points of interest data, elevation data, and routes suitable for certain modes of transport or exercise such as vehicle, pedestrian, or cycling. The route class database 102 can provide supplemental information as to which routes are specifically suited for types of exercise such as walking, running, cycling, and mountain biking. The user can create routes on the server 100 using the route class database 102, and then the created routes can be sent to the personal navigation device 50 via the GPRS modem 16. The use of the route class database 102 hosted on the server allows a larger amount of data to be used for creating exercise routes, and the route class database 102 can be updated constantly for providing the most up to date route data to the user.

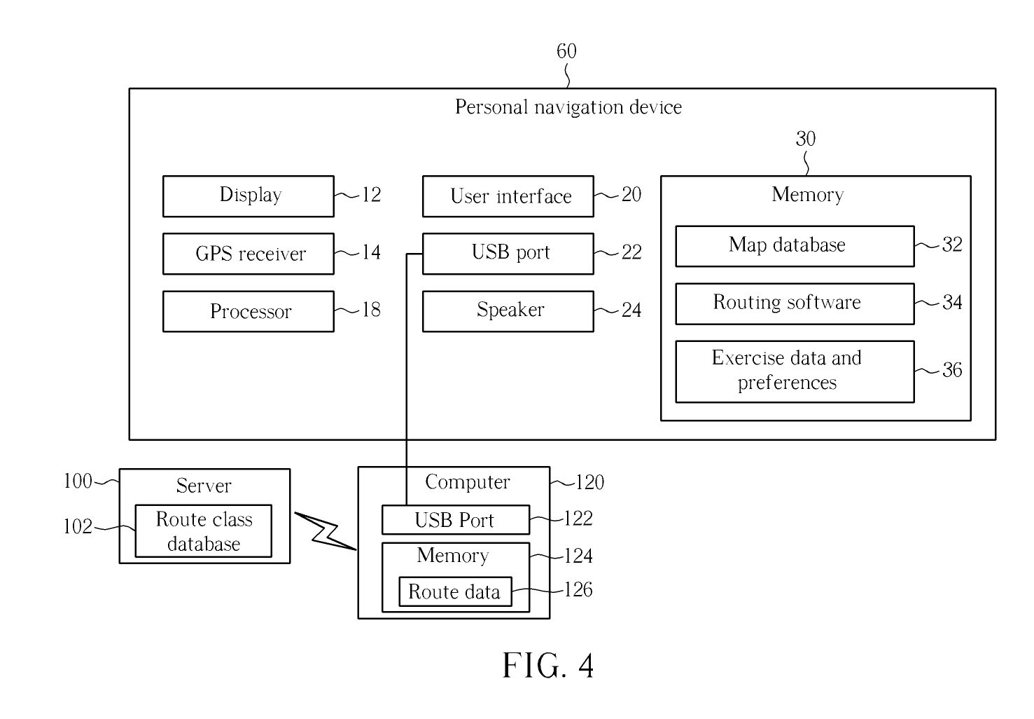

Please refer to FIG. 4. FIG. 4 is a block diagram of a personal navigation device 60 according to another embodiment of the present invention. Differing from the personal navigation device 10 shown in FIG. 1, the personal navigation device 60 contains a Universal Serial Bus (USB) port 22 for allowing data to be exchanged with a computer 120. The USB port 22 of the personal navigation device 60 communicates with a USB port 122 of the computer 120. The USB port 22 and the USB port 122 are only used as examples, and a variety of other communication port standards can be used instead of USB, such as the Institute of Electrical and Electronics Engineers (IEEE) 1394 standard, the External Serial Advanced Technology Attachment (eSATA) standard, etc. Instead of the personal navigation device 60 directly connecting to the server 100 via the Internet as was shown in FIG. 3, the personal navigation device 60 shown in FIG. 4 connects to the server 100 via the connection to the computer 120. In order to obtain additional exercise route information, the user can first use a route creating application installed on the computer 120 to connect to the route class database 102 stored in the server 100. One or more exercise routes can be created based on the information obtained from the route class database 102, and these exercise routes can be stored as route data 126 in a memory 124 of the computer 120. Then, once the USB port 22 of the personal navigation device 60 is connected to the USB port 122 of the computer 120, the route data 126 can be exported from the computer 120 to the memory 30 of the personal navigation device 60 for use by the routing software 34. Therefore, even if the personal navigation device 60 does not have the capability of connecting directly to the Internet, a communication port such as the USB port 22 can be used to connect to the computer 120, which in turn connects to the Internet for communicating with the server 100.

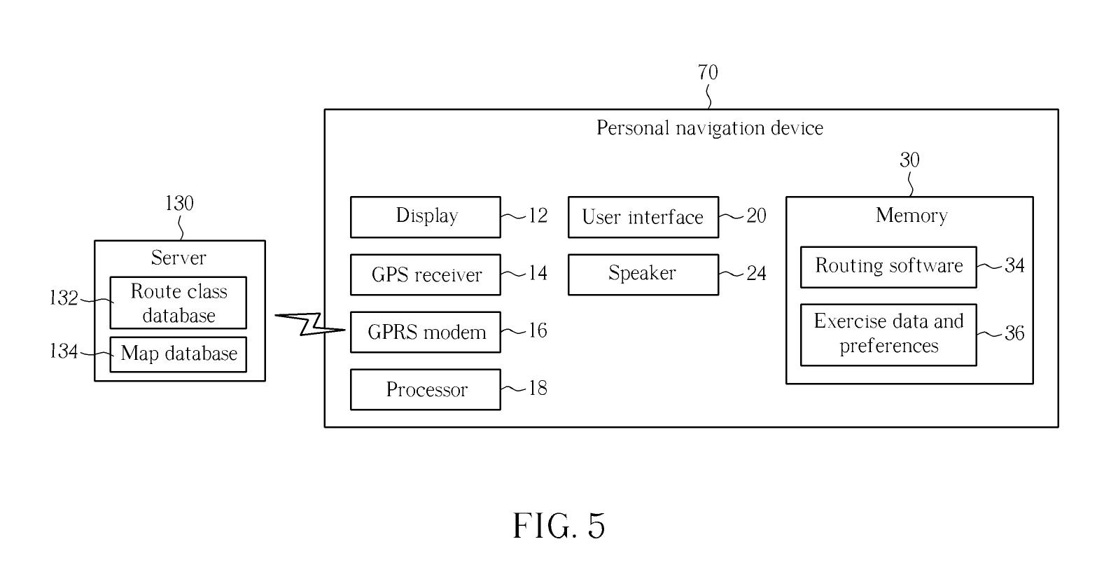

Please refer to FIG. 5. FIG. 5 is a block diagram of a personal navigation device 70 according to another embodiment of the present invention. Like the personal navigation device 50 shown in FIG. 3, the personal navigation device 70 also contains a GPRS modem 16 for communicating with a server 130. Differing from the personal navigation device 50 of FIG. 3, however, the memory 30 of the personal navigation device 70 does not contain a map database, and instead a map database 134 and the route class database 132 are both stored in the server 130. Thus, it is necessary for the personal navigation device 70 to communicate with the server 130 for all database access. An advantage to this system is the required capacity of the memory 30 of the personal navigation device 70 can be considerably reduced. Furthermore, the map database 134 stored in the server 130 can be updated much more frequently than would be feasible for the user of the personal navigation device 70 to update a map database stored locally in the personal navigation device 70.

In summary, the present invention provides a way for a user to select a customized exercise route that satisfies the user's input route parameter preferences. The user is given a large assortment of options to choose from, and a customized exercise route is thereby created. As a result, the user has considerably more control over what type of route will be selected while still retaining the convenience of the personal navigation device helping plan the route, the user can exercise on a greater variety of routes, and the user can continue training on level-appropriate exercise routes. Moreover, having a greater variety of training options makes it more likely that the user will find and continue with a training program that is enjoyable and challenging to the user.

Those skilled in the art will readily observe that numerous modifications and alterations of the device and method may be made while retaining the teachings of the invention.

What is claimed is:

1. A method of creating an exercise route for a user, the method comprising:
providing a database comprising geographic data;
receiving a plurality of input route parameters from the user, the input route parameters comprising a type of exercise to be performed on the exercise route;
processing the geographic data from the database and the plurality of input route parameters to define the exercise route from a starting point to an ending point; and
presenting the exercise route to the user.

2. The method of claim 1, wherein the plurality of input route parameters further comprises a selected difficulty level of the exercise route.

3. The method of claim 2, wherein the selected difficulty level of the exercise route indicates a total elevation gain throughout the exercise route.

4. The method of claim 1, wherein the type of exercise to be performed on the exercise route is selected from the group consisting of walking, running, cycling, and mountain biking.

5. The method of claim 1, wherein the plurality of input route parameters further comprises one or more points of interest to be visited along the exercise route.

6. The method of claim 1, wherein the plurality of input route parameters further comprises a category of points of interest to be visited along the exercise route, the exercise route defined in order to visit a maximum number of points of interest included in the category of points of interest while at the same time satisfying all other input route parameters indicated by the user.

7. The method of claim 1, wherein the plurality of input route parameters further comprises a total distance to be covered on the exercise route.

8. The method of claim 1, wherein at least one of the starting point and the ending point of the exercise route is selected by the user.

9. The method of claim 8, wherein the starting point and the ending point of the exercise route are selected to be located at the same place.

10. The method of claim 8, wherein when a departure route and a return route of the exercise route are selected to be different from each other.

11. The method of claim 1, wherein the plurality of input route parameters further comprises current progress on a training program followed by the user, the exercise route being defined to match the user's training program.

12. The method of claim 1, wherein the plurality of input route parameters further comprises a number of calories that the user wishes to burn on the exercise route.

13. The method of claim 1, wherein the exercise route is presented to the user on a personal navigation device, the personal navigation device comprising a memory for storing the database.

14. The method of claim 1, wherein the database comprises a map database and a route class database, the map database comprising street maps, longitude, latitude, and elevation data, and the route class database comprising classifications on routes suitable for various types of exercise.

15. The method of claim 14, wherein the exercise route is presented to the user on a personal navigation device, the personal navigation device comprising a modem for connecting to both the map database and the route class database via the Internet.

16. The method of claim 15, wherein the modem is a General Packet Radio Service (GPRS) modem.

17. The method of claim 14, wherein the exercise route is presented to the user on a personal navigation device, the personal navigation device comprising a memory for storing the map database and a modem for connecting to the route class database via the Internet.

18. The method of claim 17, wherein the modem is a General Packet Radio Service (GPRS) modem.

19. The method of claim 14, wherein the exercise route is presented to the user on a personal navigation device, the personal navigation device comprising a memory for storing the map database and a first communications port for connecting to a second communications port of a computer, the computer accessing the route class database via the Internet and transmitting route information to the personal navigation device through the first and second communications ports.

20. The method of claim 19, wherein the first and second communications ports are Universal Serial Bus (USB) communications ports.
